(19) United States
(12) Patent Application Publication
(10) Pub. No.: US 2024/0276606 A1
(43) Pub. Date: Aug. 15, 2024

(54) HEATING PIECE UTILIZING CARBON FIBERS AS WEARABLE HEATING CONDUCTORS

(71) Applicants: MEC ADDHEAT (KAIPING) CO. ,LTD., Kaiping City (CN); SainStore Technology Co.,Ltd, Dongguan (CN)

(72) Inventors: CHIENCHOU CHEN, Kaiping City (CN); Tianle Cheng, Dongguan (CN); Liping Huang, Dongguan (CN)

(21) Appl. No.: 18/623,494

(22) Filed: Apr. 1, 2024

(30) Foreign Application Priority Data
Jan. 11, 2024 (CN) 202410042876.6

(51) Int. Cl. H05B 3/34; H05B 3/00; H05B 3/14

(52) U.S. Cl. CPC H05B 3/342; H05B 3/0019; H05B 3/145

(57) ABSTRACT

A heating piece utilizing carbon fibers as wearable heating conductors. The carbon fibers are directly connected to a flexible printed circuit board, reducing heat loss and improving heating efficiency. The heating piece is ultra-light, flexible, and can meet requirements for various shapes. The design and process have addressed the durability under washing machine conditions and structure simplification issues. A main heating piece includes a flexible printed circuit board, a solder pad, hot melt adhesive sheets and TPU films, which forms a confined space and ensures safety of usage. A subsidiary heating piece is electrically connected to the main heating piece through the flexible printed circuit board, to achieve efficient collaborative operation. The disclosure reduces the number of wire connections and optimizes the layout of power wires, enhancing user experience, stability, and lifespan. The method realizes the formation of an integrated structure through a hot-melt method, further strengthening its machine-wash durability.

### TECHNICAL FIELD

The present disclosure relates to the technical field of wearable heated clothing, in particular to a heating piece utilizing carbon fibers as wearable heating conductors.

### BACKGROUND

Heated clothing has a broad prospect in many fields such as outdoor sports and adventure, health care, military applications, and daily life.

Firstly, in the field of outdoor sports and adventure, heated clothing has great potential. For people who need to perform activities in cold environments, such as mountain climbers and skiers, how to maintaining body temperature becomes more vital. A traditional solution is to wear bulky clothing. This limits freedom of movement, and increases a risk of accidents.

The heated clothing can quickly provide heat when needed, helping users stay comfortable in the cold without affecting an ability of performing activities. This advantage undoubtedly attracts a large number of outdoor sports enthusiasts, promoting the heated clothing in this field.

Secondly, in the field of health care, the heated clothing also shows great application value. For people who need to lie in bed for a long time or have poor blood circulation, such as the elderly and recovering patients, a partial heating function of the heated clothing can promote blood circulation and relieve pain and discomfort. Therefore, quality of life is improved. This improves the comfort of patients, and helps to speed up the recovery process and reduce the medical burden. With the strengthening of social care for the elderly and disabled, demands for the heated clothing in this field is expected to grow continuously.

In addition, the heated clothing is further applied in the military field. Soldiers often face a variety of extreme environments when performing duties. Therefore, maintaining of the body temperature is of great importance to maintaining combat effectiveness. A continuous heating function of the heated clothing can help soldiers to maintain their body temperatures and combat effectiveness under cold conditions, to improve combat efficiency. This improves the combat effectiveness of the army, and helps to safeguard the lives of soldiers.

In daily life, the heated clothing also has a broad prospect. With growing demands of consumers for fashion and comfort, a thin and lightweight design and a temperature adjusting function of the heated clothing provide users with a more comfortable and fashionable wearing experience. Whether in the cold winter or rooms with low indoor air-conditioning temperatures, the heated clothing can provide users with proper warmth, to improve the comfort of life.

As a kind of clothes, it is necessary to washing the heated clothing by a washing machine, for example:

1. Keep the clothes clean: The heated clothing or other clothing are stained with body dirt, sweat stains, and bacteria after being worn. These stains can be effectively removed through washing by the washing machine, to keep the clothes clean.

2. Prolong service life: Proper cleaning and maintenance can prolong the service life of the heated clothing. Stains and bacteria on the clothes can be removed through washing by the washing machine, to prevent the stains and bacteria from further penetrating into clothing fibers, and reduce damages to the clothes.

3. Maintain performance: Heating elements and wires in the heated clothing need to be properly protected. Dust and stains can be prevented from affecting performance of heating elements through regularly washing by the washing machine.

4. Convenience: The heated clothing can be easy to washing by the washing machine, to save a large amount of time and energy.

Based on this, as an innovative product integrating advanced heating technologies, core components such as heating pieces are disposed in several parts (such as chest, back, and lumbar) of the heated clothing. However, when such heated clothing needs to be washed by the washing machine, there are two key technical challenges. Firstly, how to implement excellent machine washability (a capability to maintain original positions, and prevent displacement, deformation, or damages) in a washing process, and enable the heated clothing to adapt to the washing environment of the machine. Secondly, when multiple heating pieces are distributed on the heated clothing, how to ensure that the heating pieces work better together, enable the temperature to be transferred more uniformly, simplify a wiring design, and reduce complexity, so that they can be more simple structure to make the heating pads more uniform, and enable the heated clothing to be washed by the machine with a simple structure. How to resolve the two technical problems is a core problem to be overcome in the present disclosure.

### SUMMARY

In view of the above-mentioned defects in the prior art, the present disclosure provides a heating piece utilizing carbon fibers as wearable heating conductors, to resolve the foregoing problems in the background, for example, how to ensure the heating piece has excellent machine washability in a washing process of a washing machine, and how to perform cooperative work of the multiple heating pieces, implement uniform transfer of the temperature, and simplify wiring.

To resolve the foregoing technical problems, the present disclosure adopts the following technical solutions: A heating piece utilizing carbon fibers as wearable heating conductors includes: a main heating piece, a subsidiary heating piece, a power wire, and a control unit connection wire, where

the main heating piece includes a flexible printed circuit board and a first heating unit;

the flexible printed circuit board includes a solder pad, and the subsidiary heating piece comprises a second heating unit; and

the first heating unit, the second heating unit, the power wire, and the control unit connection wire are electrically connected to the flexible printed circuit board through the solder pad separately.

As a further solution of the present disclosure, the first heating unit and the second heating unit each comprise a carbon fiber heating wire and a circuit, and the carbon fiber heating wire is electrically connected to the solder pad on the flexible printed circuit board through the circuit.

As a further solution of the present disclosure, the main heating piece further includes a first film layer, a first hot melt adhesive sheet, a second hot melt adhesive sheet, and a second film layer;

the first film layer, the first hot melt adhesive sheet, the flexible printed circuit board, the second hot melt adhesive sheet, and the second film layer are sequentially arranged from bottom to top;

the first film layer includes upper space, and the first heating unit and a flexible printed circuit board with a solder pad are disposed in the upper space of the first film layer;

the flexible printed circuit board comprises a lower position and an upper position;

at the lower position and the upper position of the flexible printed circuit board, the first hot melt adhesive sheet is disposed at a lower position corresponding to position of the solder pad, and the second hot melt adhesive sheet is disposed at an upper position corresponding to a position of the solder pad;

the second film layer corresponds to the first film layer, and the second film layer covers the first film layer; and

the first film layer, the first hot melt adhesive sheet, the second hot melt adhesive sheet, and the second film layer form an integrated structure in a hot melting manner, to enable space at an upper side of the first film layer to be confined space, and enable positions at which the flexible printed circuit board, the first heating unit, and the second heating unit are connected to the flexible printed circuit board through circuits, and positions at which the power wire is connected to the flexible printed circuit board, and positions at which the control unit connection wire is connected to the flexible printed circuit board to be thermally melt in the confined space.

As a further solution of the present disclosure, there are more than two first hot melt adhesive sheets and more than two second hot melt adhesive sheets.

As a further solution of the present disclosure, the heating piece utilizing carbon fibers as wearable heating conductors further includes a lower fabric layer and an upper fabric layer, a bottom surface of the first film layer is fastened to the lower fabric layer, and a top surface of the second film layer is fastened to the upper fabric layer.

As a further solution of the present disclosure, the first heating unit further includes a thermistor, and the thermistor is electrically connected to the flexible printed circuit board through the solder pad.

As a further solution of the present disclosure, the first film layer and the second film layer are TPU films, and there are more than two subsidiary heating pieces.

A method for significantly improving machine washing stability via a heating piece utilizing carbon fibers as wearable heating conductors. The method includes the following steps:

step 1, providing a main heating piece, where the main heating piece includes a first film layer, a first hot melt adhesive sheet, a flexible printed circuit board, a second hot melt adhesive sheet, and a second film layer; and a solder pad is disposed on the flexible printed circuit board;

step 2, dividing an upper side of the first film layer into upper space, and disposing a first heating unit and a flexible printed circuit board with a solder pad in the upper space;

step 3, electrically connecting the first heating unit to the flexible printed circuit board through the solder pad; and providing a power wire, a control unit connection wire, and more than two subsidiary heating pieces, and electrically connecting the second heating unit, the power wire, and the control unit connection wire on the subsidiary heating pieces to the flexible printed circuit board through the solder pad;

step 4, at the lower position and the upper position of the flexible printed circuit board, disposing the first hot melt adhesive sheet at a lower position corresponding to position of the solder pad, and disposing the second hot melt adhesive sheet at an upper position corresponding to a position of the solder pad;

step 5, providing a second film layer, enabling the second film layer to correspond to the first film layer, and covering the second film layer on the first film layer; and

step 6, performing hot melting on the first film layer, the first hot melt adhesive sheet, the second hot melt adhesive sheet, and the second film layer to form an integrated structure, enable space at an upper side of the first film layer to be confined space, and enable positions at which the flexible printed circuit board, the first heating unit, and the second heating unit are connected to the flexible printed circuit board through circuits, and positions at which the power wire is connected to the flexible printed circuit board, and positions at which the control unit connection wire is connected to the flexible printed circuit board to be thermally melt in the confined space.

As a further solution of the present disclosure, the heating piece utilizing carbon fibers as wearable heating conductors further includes a double-sided self-adhesive. In step 1, the flexible printed circuit board is pre-positioned on the first film layer via the double-sided self-adhesive.

As a further solution of the present disclosure, there are two double-sided self-adhesives.

Compared with the conventional technologies, the present disclosure has the following beneficial effect: Durability under washing machine conditions and structure simplification issues are resolved. A main heating piece includes a flexible printed circuit board, a solder pad, hot melt adhesive sheets and TPU films, which forms a confined space and ensures safety of usage. A subsidiary heating piece is electrically connected to the main heating piece through the flexible printed circuit board, to achieve efficient collaborative operation. The present disclosure reduces the number of wire connections and optimizes the layout of power wires, enhancing user experience, stability, and lifespan. The method of the present disclosure realizes the formation of an integrated structure through a hot-melt method, further strengthening its machine-wash durability. It realizes the integrated functionality at two levels in heated clothing, improving safety, work efficiency, stability, and aesthetics.

Additional aspects and advantages of the present disclosure will be partly provided in the following description, and partly become evident in the following description or understood through the practice of the present disclosure.

### BRIEF DESCRIPTION OF THE DRAWINGS

To describe the technical solutions in the embodiments of the present disclosure or in the prior art more clearly, the accompanying drawings required for describing the embodiments or the prior art will be described briefly below. Apparently, the accompanying drawings in the following description show some embodiments of the present disclosure, and a person of ordinary skill in the art may still derive other drawings from these accompanying drawings without creative efforts.

FIG. 1 is a schematic diagram of a structure according to the present disclosure;

FIG. 2 is a schematic diagram of a structure when a main heating piece is fitted with subsidiary heating pieces according to the present disclosure;

FIG. 3 is an enlarged view of a part A in FIG. 2; and

FIG. 4 is an enlarged view of a part B in FIG. 2.

### REFERENCE NUMERALS

10 main heating piece 1, subsidiary heating piece 2, power wire 3, control unit connection wire 4, first film layer 5, first hot melt adhesive sheet 6, flexible printed circuit board 7, second hot melt adhesive sheet 8, second film layer 9, first heating unit 10, second heating unit 11, solder pad 12, lower fabric layer 13, upper fabric layer 14, thermistor 15, double-sided self-adhesive 16, battery wire connector 17, temperature controller 18, circuit 19, carbon fiber heating wire 20.

### DETAILED DESCRIPTION OF EMBODIMENTS

The technical solutions in the embodiments of the present disclosure will be clearly and completely described below. Apparently, the described embodiments are merely a part of, not all of, the embodiments of the present disclosure. All other embodiments obtained by a person of ordinary skill in the art based on embodiments of the present disclosure without creative efforts should fall within the protection scope of the present disclosure.

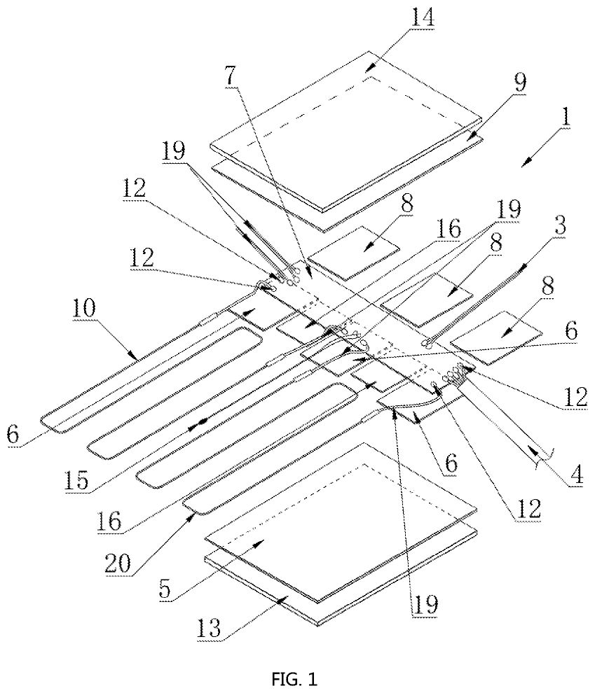

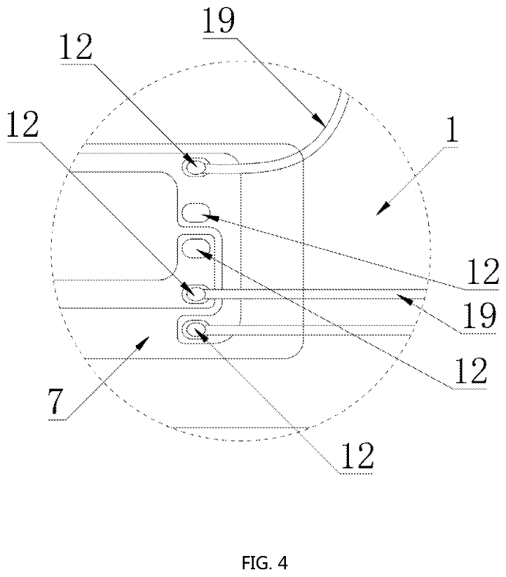

Refer to FIG. 1 to FIG. 4, in embodiments of the present disclosure, a heating piece utilizing carbon fibers as wearable heating conductors includes: a main heating piece 1, a subsidiary heating piece 2, a power wire 3, and a control unit connection wire 4. One end of the power wire 3 is electrically connected to a flexible printed circuit board 7, and the other end of the power wire 3 is electrically connected to a battery wire connector 17. One end of the control unit connection wire 4 is electrically connected to the flexible printed circuit board 7, and the other end of the control unit connection wire 4 is electrically connected to a temperature controller 19. The flexible printed circuit board 7 uses a soft flexible printed circuit board (Flexible Printed Circuit Board) technology.

The main heating piece 1 includes a first film layer 5, a first hot melt adhesive sheet 6, a flexible printed circuit board 7, a second hot melt adhesive sheet 8, a second film layer 9, and a first heating unit 10. In specific implementation, as an upper outer garment, the front of the heated clothing generally has a zipper that facilitates putting on and taking off. Therefore, the heating piece at a back position is closer to the heating piece at a left chest position, a heating piece at a right chest position, a heating piece at a sleeve area, a heating piece at a lumbar position. The heating piece at the back position is actually located in the middle of all the heating pieces in the heated clothing. The back heating piece is taken as the main heating piece. A more equal distance indicates same impedance of an electronic wire, to achieve a more uniform temperature between the heating pieces and reduce a connection length of the circuit 19.

The subsidiary heating piece 2 includes a second heating unit 11. The first film layer 5, the first hot melt adhesive sheet 6, the flexible printed circuit board 7, the second hot melt adhesive sheet 8, and the second film layer 9 are sequentially arranged from bottom to top.

In addition, “machine washability” means a capability of maintaining an original position and an original shape of the flexible circuit board 7, especially a position of the solder pad 12 relating to electrical connection, and preventing displacement, deformation, and damage via a hot melt structure of a hot melt adhesive sheets and thin film layers when the integrated heating piece of the heated clothing is stirred in a washing machine. This stability ensures that the heating pieces are still in good working conditions and have heating effect after the heated clothing is washed in the washing machine.

In addition, the “machine washability” also implies strong sealing effect on the solder pad 12 disposed on an important circuit connection position. Under strong stirring of the washing machine, if the sealing effect of the heating piece is poor, water or other laundry liquid may penetrate in the heating piece. As a result, the heating piece is damaged or effectiveness is lost. Therefore, to implement machine washing stability, a sealing method for the heating piece is sufficiently strong and effective, and can prevent water and other liquids from penetrating in a machine washing process, to ensure that the heating piece is safe and durable.

The integrated structure formed by hot melting multiple hot melt adhesive sheets, film layers, and flexible printed circuit board 7 uses characteristics of flexible materials such as the hot melt adhesive sheets and the film layers, and implements usage effect on flexibly removing a stirring force in the machine washing process.

Therefore, “machine washability” not only means stability of the heating piece in the washing machine, but also implies good waterproof sealing effect. This ensures safety and reliability of the heated clothing in the machine washing process.

The flexible printed circuit board 7 includes: a solder pad 12. The first film layer 5 includes upper space. The first heating unit 10 and a flexible printed circuit board 7 with a solder pad 12 are disposed in the upper space of the first film layer 5.

The first heating unit 10, the second heating unit 11, the power wire 3, and the control unit connection wire 4 are electrically connected to the flexible printed circuit board 7 through the solder pad 12 separately. The flexible printed circuit board 7 includes a lower position and an upper position.

At the lower position and the upper position of the flexible printed circuit board 7, the first hot melt adhesive sheet 6 is disposed at a lower position corresponding to position of the solder pad 12, and the second hot melt adhesive sheet 8 is disposed at an upper position corresponding to a position of the solder pad 12.

The second film layer 9 corresponds to the first film layer 5. In a good solution, the second film layer 9 completely covers the first film layer 5, to fit with hot melting.

The first film layer 5, the first hot melt adhesive sheet 6, the second hot melt adhesive sheet 8, and the second film layer 9 form an integrated structure in a hot melting manner, to enable space at an upper side of the first film layer 5 to be confined space, and enable positions at which the flexible printed circuit board 7, the first heating unit 10, and the second heating unit 11 are connected to the flexible printed circuit board 7 through circuits 19, and positions at which the power wire 3 is connected to the flexible printed circuit board 7, and positions at which the control unit connection wire 4 is connected to the flexible printed circuit board 7 to be thermally melt in the confined space. There is no air in the confined space. The term “confined space” is only for convenience of description, which is an embodiment known to a person of ordinary skill in the art.

There are more than two first hot melt adhesive sheets 6 and more than two second hot melt adhesive sheets 8, and used with the solder pad 12 at different positions. The first film layer 5 and the second film layer 9 are TPU films.

As a further solution of the present disclosure, the heating piece utilizing carbon fibers as wearable heating conductors further includes a lower fabric layer 13 and an upper fabric layer 14, a bottom surface of the first film layer 5 is fastened to the lower fabric layer 13, and a top surface of the second film layer 9 is fastened to the upper fabric layer 14. The first heating unit 10 and the second heating unit 11 each include a carbon fiber heating wire 20 and a circuit 19, and the carbon fiber heating wire 20 is electrically connected to the solder pad 12 on the flexible printed circuit board 7 through the circuit 19.

There are more than two subsidiary heating pieces 2, for example, may be a left chest heating piece, a right chest heating piece, a lumbar heating piece, a sleeve heating piece, which are extended embodiments known to a person of ordinary skill in the art.

The first heating unit 10 further includes a thermistor 15, and the thermistor 15 is electrically connected to the flexible printed circuit board 7 through the solder pad 12. NTC (thermistor) is used for temperature protection. When a temperature of the heating piece exceeds a preset value, a resistance value of the NTC thermistor is changed. When an MCU of the temperature controller 18 detects that a resistance value of the NTC thermistor is changed, an instruction is sent to cut off the output current or reduce the output current, to enable a temperature of the heating pieces (the main heating piece 1 and the subsidiary heating pieces 2) to be reduced to a safe value, and implement temperature protection and thermostat.

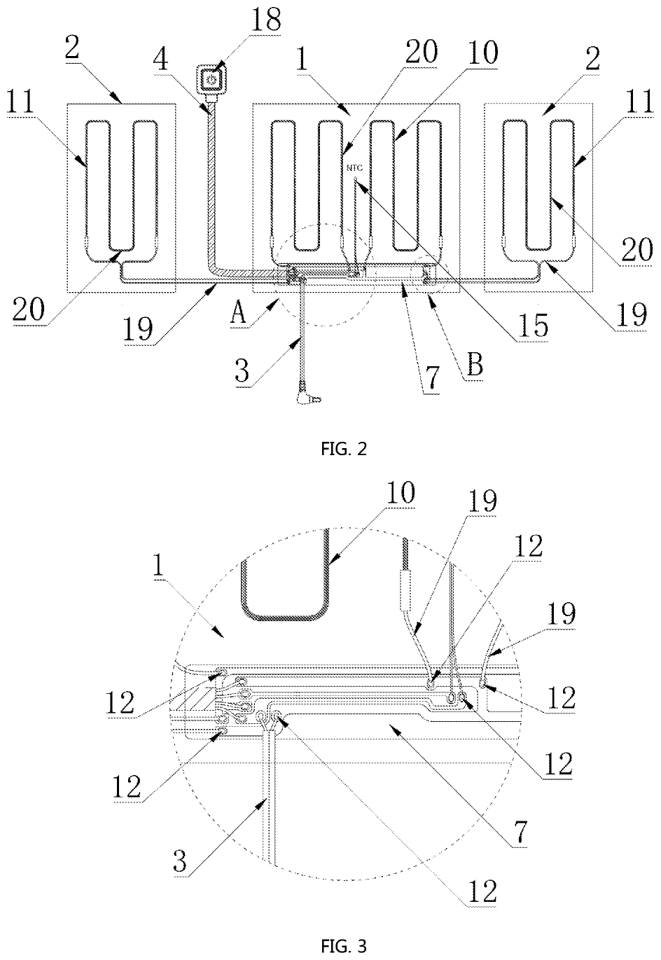

In this embodiment of FIG. 2, the NTC thermistor is disposed on only the main heating piece 1, and a person of ordinary skill in the art may separately dispose the NTC thermistor on each of the heating pieces, to accurately control the temperature. These extended embodiments are understood and implemented by a person of ordinary skill in the art.

A method for significantly improving machine washing stability via a heating piece utilizing carbon fibers as wearable heating conductors. The method includes the following steps:

Step 1: Provide a main heating piece 1, where the main heating piece 1 includes a first film layer 5, a first hot melt adhesive sheet 6, a flexible printed circuit board 7, a second hot melt adhesive sheet 8, and a second film layer 9; and a solder pad 12 is disposed on the flexible printed circuit board 7.

Step 2: Divide an upper side of the first film layer 5 into upper space, and dispose a first heating unit 10 and a flexible printed circuit board 7 with a solder pad 12 in the upper space.

Step 3: Electrically connecting the first heating unit 10 to the flexible printed circuit board 7 through the solder pad 12; and provide a power wire 3, a control unit connection wire 4, and more than two subsidiary heating pieces 2, and electrically connect the second heating unit 11, the power wire 3, and the control unit connection wire 4 on the subsidiary heating pieces 2 to the flexible printed circuit board 7 through the circuit 19 and the solder pad 12.

Step 4: At the lower position and the upper position of the flexible printed circuit board 7, dispose the first hot melt adhesive sheet 6 at a lower position corresponding to position of the solder pad 12, and dispose the second hot melt adhesive sheet 8 at an upper position corresponding to a position of the solder pad 12.

Step 5: Provide a second film layer 9, enabling the second film layer to correspond to the first film layer 5, and covering the second film layer 9 on the first film layer 5.

Step 6: Perform hot melting on the first film layer 5, the first hot melt adhesive sheet 6, the second hot melt adhesive sheet 8, and the second film layer 9 to form an integrated structure, to enable space at an upper side of the first film layer 5 to be confined space, and enable positions at which the flexible printed circuit board 7, the first heating unit 10, and the second heating unit 11 are connected to the flexible printed circuit board 7 through circuits 19, and positions at which the power wire 3 is connected to the flexible printed circuit board 7, and positions at which the control unit connection wire 4 is connected to the flexible printed circuit board 7 to be thermally melt in the confined space.

The heating piece utilizing carbon fibers as wearable heating conductors further includes a double-sided self-adhesive 16. In step 1, the flexible printed circuit board 7 is pre-positioned on the first film layer 5 via the double-sided self-adhesive 16. There are two double-sided self-adhesives 16.

### Embodiment 1

A conventional heating piece has low heating efficiency, high weight, and poor flexibility due to improper selection of materials and improper structural design. Therefore, when the heating piece is integrated with a wearable device, how to ensure light weight, flexibility, and efficient heating performance of the heating piece is a technical problem in the industry. To overcome these problems, the present disclosure provides a heating piece utilizing carbon fibers as wearable heating conductors.

The heating piece includes a main heating piece 1, a subsidiary heating piece 2, a power wire 3, and a control unit connection wire 4. A flexible printed circuit board 7 and a first heating unit 10 are integrated on the main heating piece 1. A solder pad 12 is disposed on the flexible printed circuit board 7. The subsidiary heating piece 2 includes a second heating unit 11. The first heating unit 10, the second heating unit 11, the power wire 3, and the control unit connection wire 4 are electrically connected to the flexible printed circuit board 7 through a solder pad 12 separately.

Several key technical features in this implementation creates superior performance:

Firstly, because light weight, high strength and high thermal conductivity, carbon fiber, as the core of a heating conductor, ensures that the heating piece has excellent heating performance while maintaining light weight.

Secondly, the flexible printed circuit board 7 is directly disposed on the main heating piece 1. Therefore, flexibility and adaptability of the entire structure is improved. The flexible printed circuit board (FPCs) supports more complex circuit layouts, and adapts to irregular surfaces. This provides greater design freedom.

It is worth mentioning that an innovation of connecting the carbon fiber heating wire to the flexible printed circuit board is implemented in this solution. A conventional connection method is inflexible. The carbon fiber heating wire 20 is directly and electrically connected to the solder pad 12 on the flexible printed circuit board 7 via the circuit 19. This simplifies the overall structure, and significantly improves stability and reliability of the connection.

In addition, the highly integrated design is a highlight of the solution. The flexible printed circuit board 7 and a first heating unit 10 are integrated on the main heating piece 1, and the second heating unit 11 is integrated on the subsidiary heating piece 2. In addition, the power wire 3 and the control unit connection wire 4 are electrically connected to the flexible printed circuit board 7 through the solder pad 12. This highly integrated design ensures the compact structure and stable performance of the entire heat generating sheet, and is conducive to fitting between the subsidiary heating piece 2 and the main heating piece 1.

In this embodiment, more technical effects are achieved: Because carbon fiber is directly connected to the flexible printed circuit board, heating efficiency is excellent, and energy loss is greatly reduced. Because the heating piece is ultra-light and flexible, the heating piece meets various shape requirements while maintaining high performance. Because of outstanding durability and stability, the heating piece can work in harsh environments. When wearing the heated clothing having the heating piece, the user has greater freedom. Because of a highly integrated design, the heated clothing is easy to assemble and test in mass production.

### Embodiment 2

A main heating piece 1 (a heating piece with a single module) of heated clothing (heating clothes) is integrated with a flexible printed circuit board 7 with a solder pad 12 for inputting a power signal. Battery power is supplied to a power supply, to supply heat to the main heating piece 1, and more than two subsidiary heating pieces 2. A thermistor 15 may be connected for temperature protection.

The flexible printed circuit board 7 with a solder pad 12 has multiple functions, for example. When the flexible printed circuit board 7 is electrically connected to the first heating unit 10, the second heating unit 11, the power wire 3, and the control unit connection wire 4 through the solder pad 12, high-performance machine washability protection is provided for the connection portion of the solder pad 12.

The first hot melt adhesive sheet 6 and the second hot melt adhesive sheet 8 are respectively disposed at an upper portion and a lower portion of the solder pad 12. When the first hot melt adhesive sheet 6 and the second hot melt adhesive sheet 8 are closely attached in a hot melt manner, because of specific surface areas, protection and machine washability are implemented at the solder pad 12 and the connection position. TPU films (the first film layer 5 and the second film layer 9) that are attached at an upper side and a lower side of a position at which the first heating unit 10 (that is, the carbon fiber heating wire) and the soft FPC board are connected are integrated with the first hot melt adhesive sheet 6 and the second hot melt adhesive sheet 8 in the heat melt process. This implements partially enhanced multi-layer sealing effect in a wide range.

### Embodiment 3

This embodiment describes in detail that a heating piece utilizing carbon fibers as wearable heating conductors successfully resolves two technical problems of machine washability and cooperative work due to unique structural design and process when the heated clothing is washed in a washing machine.

Firstly, the heating piece utilizing carbon fibers as wearable heating conductors includes a main heating piece 1, a subsidiary heating piece 2, a power wire 3, and a control unit connection wire 4. The main heating piece 1, as a core component, includes a first film layer 5, a first hot melt adhesive sheet 6, a flexible printed circuit board 7, a second hot melt adhesive sheet 8, a second film layer 9, and a first heating unit 10. The second heating unit 11 is disposed on the subsidiary heating piece 2. These components are closely arranged in a carefully designed sequence, and are melt together in hot melting manner, to create a confined space at an upper side of the first film layer 5. Due to this design, water molecules cannot penetrate into the heating piece during the washing process. This ensures safety of the heated clothing during use.

Secondly, the main heating piece 1 and the subsidiary heating piece 2 are highly integrated. The flexible printed circuit board 7 is embedded in the main heating piece 1, and the subsidiary heating piece 2, the power wire 3, and the control unit connection wire 4 are connected to the flexible printed circuit board 7 through the solder pad 12. This innovative design achieves more uniform heating effect, and reduces a quantity and complexity of power wires 3. Therefore, user experience is optimized. Specifically, the main heating piece 1 and the subsidiary heating piece 2 are finely divided. In addition, the flexible printed circuit board 7 is integrated on the main heating piece 1. This enables the main heating piece 1 and the subsidiary heating piece 2 to be electrically connected to the flexible printed circuit board 7 through the power wire 3. A temperature controller 18 is electrically connected to the flexible printed circuit board 7 through the control unit connection wire 4, and a battery wire connector 17 is electrically connected to the flexible printed circuit board 7 through the power wire 3. This design ensures that power is smoothly supplied to the flexible printed circuit board 7 through the battery wire connector 17 and the power wire 3 and synchronously supplied to the temperature controller 18. The temperature controller 18 accurately controls the output of a current based on a received NTC signal, to supply the current to the flexible printed circuit board 7. When successfully receiving the current, the flexible printed circuit board 7 supplies the current to the heating piece through the power wire 3 or cut off the current supplied to the heating piece. This innovative design resolves a problem that in the conventional technologies, a plurality of heating pieces need to be electrically connected to the temperature controller 18 through the power wire 3, and the temperature controller 18 needs to be connected to the battery wire connector 17 through the power wire 3, and implement more uniform heating effect by a more scientific and reasonable layout. In addition, the design significantly reduces the quantity and complexity of the power wire 3. This further improves wearing experience of the user.

The working principle of the present disclosure is as follows: The FPC flexible printed circuit board 7 is embedded at a back position of the heated clothing, and integrated with the heating pieces to form the main heating piece 1 for receiving a current input from a battery. The main heating piece 1 has a self-contained power wire 3, is connected to the control unit connection wire 4 through an electronic circuit, to deliver current to the temperature controller 18 that has functions of a switch and a temperature controller 18. When the user needs to start the device or adjust the temperature, a current regulated by the temperature controller 18 is input by the solder pad 12 of the flexible printed circuit board 7 to the heating pieces (including the main heating piece 1 and the subsidiary heating piece 2). Because a current input position is located at the center of the back, due to equidistant effect of an electronic wire (that is, in an equidistant state, impedances of the electronic wires are the same), temperatures arriving at a left chest heating piece and a right chest heating piece are more uniform, and connection requirements for the power wire 3 are reduced.

To more intuitively illustrate the advantages of the present disclosure, the present disclosure is compared with the conventional technologies: In existing wearable heated clothing on the market, a temperature controller first inputs battery power into an internal temperature controller, and the battery power is conducted or cut off by a CPU of the temperature controller, or adjusted by adjusting a duty cycle, and then is supplied to each heating piece through the electronic wire, to achieve the heating effect. Therefore, the battery power wire needs to be physically connected to a conductor of the temperature controller for power supply. In addition, the temperature controller needs to supply power to each heating piece, electronic wires of the heating pieces need to be connected one by one to the temperature controller 18 based on the quantity of heating pieces. In addition, if an NTC (thermistor) for temperature protection is disposed on the heating piece, the thermistor needs to be connected to the temperature controller through additional electronic wires. In the present disclosure, the FPC flexible printed circuit board 7 disposed in the heating piece on the back of the heated clothing is used as a connection medium of the current. The FPC flexible printed circuit board 7 is further connected to the control unit connection wire 4 by soldering, to realize current connection to the temperature controller 18. Therefore, the quantities of wires are reduced, man-hours are saved, and beauty and wearing comfort are improved.

In addition, to further strengthen the machine washability, the first hot melt adhesive sheet 6 and the second hot melt adhesive sheet 8 are respectively disposed on the upper side and the lower side of the “connection position of the solder pad 12” of the flexible printed circuit board 7. The first hot melt adhesive sheet 6 and the second hot melt adhesive sheet 8 have specific surface areas after being closely attached by hot melting, the solder pad 12 and peripheral parts thereof are effectively protected, and machine washability is improved. This improves machine washability of the heated clothing in the washing process, prolongs service life of the heated clothing, and improves performance stability.

In the present disclosure, unless otherwise clearly specified, meanings of terms “disposed”, “installed”, and “connected with” should be understood in a board sense. For example, a connection may be a fixed connection, a removable connection, or an integral connection; may be a mechanical connection or an electrical connection; may be a direct connection or an indirect connection by using an intermediate medium; or may be intercommunication between two components or interaction between two components. Unless otherwise clearly specified, a person of ordinary skill in the art can understand a specific meaning of the term in the present disclosure based on a specific situation.

It is apparent for those skilled in the art that the present disclosure is not limited to details of the above exemplary embodiments, and that the present disclosure may be implemented in other specific forms without departing from the spirit or basic features of the present disclosure. The embodiments should be regarded as exemplary and non-limiting in every respect, and the scope of the present disclosure is defined by the appended claims rather than the above description. Therefore, all changes falling within the meaning and scope of equivalent elements of the claims should be included in the present disclosure.

1. A heating piece utilizing carbon fibers as wearable heating conductors, comprising:
a main heating piece, a subsidiary heating piece, a power wire, and a control unit connection wire, wherein
the main heating piece comprises a flexible printed circuit board and a first heating unit;
the flexible printed circuit board comprises a solder pad, and the subsidiary heating piece comprises a second heating unit;
the first heating unit, the second heating unit, the power wire, and the control unit connection wire are electrically connected to the flexible printed circuit board through the solder pad respectively; and
the first heating unit and the second heating unit each comprise a carbon fiber heating wire and a circuit, and the carbon fiber heating wire is electrically connected to the solder pad on the flexible printed circuit board through the circuit.

2. The heating piece utilizing carbon fibers as wearable heating conductors according to claim 1, wherein
the main heating piece further comprises a first film layer, a first hot melt adhesive sheet, a second hot melt adhesive sheet, and a second film layer;
the first film layer, the first hot melt adhesive sheet, the flexible printed circuit board, the second hot melt adhesive sheet, and the second film layer are sequentially arranged from bottom to top;
the first film layer comprises upper space, and the first heating unit and a flexible printed circuit board with a solder pad are disposed in the upper space of the first film layer;
the flexible printed circuit board comprises a lower position and an upper position;
at the lower position and the upper position of the flexible printed circuit board, the first hot melt adhesive sheet is disposed at a lower position corresponding to position of the solder pad, and the second hot melt adhesive sheet is disposed at an upper position corresponding to a position of the solder pad;
the second film layer corresponds to the first film layer, and the second film layer covers the first film layer; and
the first film layer, the first hot melt adhesive sheet, the second hot melt adhesive sheet, and the second film layer form an integrated structure in a hot melting manner, to enable space at an upper side of the first film layer to be confined space, and enable positions at which the flexible printed circuit board, the first heating unit, and the second heating unit are connected to the flexible printed circuit board through circuits, and positions at which the power wire is connected to the flexible printed circuit board, and positions at which the control unit connection wire is connected to the flexible printed circuit board to be thermally melt in the confined space.

3. The heating piece utilizing carbon fibers as wearable heating conductors according to claim 2, wherein there are more than two first hot melt adhesive sheets and more than two second hot melt adhesive sheets.

4. The heating piece utilizing carbon fibers as wearable heating conductors according to claim 2, further comprising a lower fabric layer and an upper fabric layer, a bottom surface of the first film layer is fastened to the lower fabric layer, and a top surface of the second film layer is fastened to the upper fabric layer.

5. The heating piece utilizing carbon fibers as wearable heating conductors according to claim 1, wherein the first heating unit further comprises a thermistor, and the thermistor is electrically connected to the flexible printed circuit board through the solder pad.

6. The heating piece utilizing carbon fibers as wearable heating conductors according to claim 2, wherein the first film layer and the second film layer are TPU films.

7. The heating piece utilizing carbon fibers as wearable heating conductors according to claim 1, wherein there are more than two subsidiary heating pieces.
